(19) United States
(12) Patent Application Publication
(10) Pub. No.: US 2008/0063178 A1
(43) Pub. Date: Mar. 13, 2008

(54) Agent call flow monitoring and evaluation

(75) Inventors: Jonathan Paden, Austin, TX (US); Jon Harris, Little Elm, TX (US); Matthew A. Dixon, Chicago, IL (US); Kurt Joseph, Austin, TX (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/504,669

(22) Filed: Aug. 16, 2006

(51) Int. Cl. H04M 3/00

(52) U.S. Cl. 379/265.06

(57) ABSTRACT

Agent performance is monitored. Multiple segments of a first communications session are monitored based on corresponding triggers that trigger the monitoring of the multiple segments. Characteristic data of the multiple segments is obtained. The characteristic data of the first communications session and characteristic data of a second communications session are grouped. The characteristic data of the first communications session is subject to common evaluation with the characteristic data of the second communications session.

### BACKGROUND

1. Field of the Disclosure

The present disclosure relates to agent call flow monitoring and evaluation. More particularly, the present disclosure relates to monitoring and evaluating details of communications sessions between callers and agents.

2. Background Information

Services are provided over communications networks by agents. Agents may be trained humans or programmed machines. The agents follow variable scripts to solicit information from a caller. Responses from the caller are used to proceed through the script. Agents may use resources such as customer relation management (CRM) tools and knowledge base tools to provide assistance to the caller.

In attempting to improve call flow, it is difficult to assess whether a proposal will be productive because the details of existing call flow characteristics are not monitored. Therefore, the detailed information needed to evaluate the purported benefits of a proposal is not available and it is difficult to justify the proposal.

For example, a consultant may propose changing a call flow by programming an interactive voice response agent program to request a call-back number from a customer in case the call is disconnected while waiting to be transferred to a human agent. The call-back number could then be passed to the human agent over a data network when the human agent is available and the call is transferred to the human agent. However, it is virtually impossible to reliably demonstrate that such a change in the call flow will provide a benefit.

Currently, average handle time for communications sessions is measured. However, even if agents are assigned to particular workgroups based on the type of tasks they perform, the average duration of different call types handled by a workgroup will vary widely as the number and type of troubleshooting steps vary among different tasks performed by the workgroup. Therefore, performance as measured by average handle time at the workgroup level is not precise.

As a result of the inability to accurately measure detailed call flow characteristics, some enterprises are dissuaded from attempting to improve call flows with even minor changes.

### BRIEF DESCRIPTION OF THE DRAWINGS

FIG. 1 shows an exemplary general computer system that includes a set of instructions for agent call flow monitoring and evaluation, according to an aspect of the present disclosure;

FIG. 2 shows an exemplary agent workstation graphical user interface for agent call flow monitoring and evaluation, according to an aspect of the present disclosure;

FIG. 3 shows an exemplary telecommunications network for agent call flow monitoring and evaluation, according to an aspect of the present disclosure;

FIG. 4 shows an exemplary network for agent call flow monitoring and evaluation, according to an aspect of the present disclosure;

FIG. 5 shows an exemplary process for collecting characteristic data of a communications session, according to an aspect of the present disclosure; and

FIG. 6 shows an exemplary method of analyzing characteristic data of communications sessions, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

According to an aspect of the present disclosure, a method of monitoring agent performance includes monitoring multiple segments of a first communications session based on corresponding triggers that trigger the monitoring of the multiple segments. Characteristic data of the multiple segments is obtained. The characteristic data of the first communications session and characteristic data of a second communications session are grouped. The characteristic data of the first communications session is subject to common evaluation with the characteristic data of the second communications session.

According to another aspect of the present disclosure, the triggers are generated based on agent interaction with at least one agent interface.

According to yet another aspect of the present disclosure, the agent interaction with the at least one interface comprises a request to display specified content.

According to still another aspect of the present disclosure, the start of each segment is time stamped.

According to another aspect of the present disclosure, the end of each segment is time stamped.

According to yet another aspect of the present disclosure, a duration of each segment is compared with a predetermined threshold.

According to still another aspect of the present disclosure, a duration of a segment is displayed to the agent in association with a predetermined threshold.

According to another aspect of the present disclosure, the common evaluation determines a mean duration of at least one common segment of the first and the second communications sessions.

According to yet another aspect of the present disclosure, the common evaluation determines a duration variance of at least one common segment of the first and the second communications sessions.

According to still another aspect of the present disclosure, a first segment and a second segment are temporally differentiable.

According to another aspect of the present disclosure, a first segment corresponds to the use of a first tool by an agent and a second segment corresponds to the use of a second tool by the agent.

According to yet another aspect of the present disclosure, a first segment corresponds to a period where a first document is open for the agent and a second segment corresponds to a period where a second document is open for the agent.

According to still another aspect of the present disclosure, the triggers include at least one call initiation to a third party.

According to another aspect of the present disclosure, the start of the first communications session is measured from a time when the agent receives a call.

According to yet another aspect of the present disclosure, the agent receives the call after the call is processed by an intelligent peripheral.

According to still another aspect of the present disclosure, characteristic data of an interaction between a caller and the intelligent peripheral is subject to the common evaluation with the characteristic data of the first communications session and the characteristic data of the second communications session.

According to another aspect of the present disclosure, the first segment and the second segment correspond to differentiable progressive agent activities during the first communications session.

According to yet another aspect of the present disclosure, the differentiable progressive agent activities correspond to tasks required for the agent to complete the call.

According to an aspect of the present disclosure, a computer readable medium for storing a program that monitors agent performance includes a monitoring code segment that monitors multiple segments of a first communications session, based on corresponding triggers that trigger the monitoring of the multiple segments. An obtaining code segment obtains characteristic data of the multiple segments. The characteristic data of the first communications session and characteristic data of a second communications session are grouped. The characteristic data of the first communications session is subject to common evaluation with characteristic data of the second communications session.

According to an aspect of the present disclosure, a module for monitoring agent performance includes a monitor that monitors multiple segments of a first communications session based on corresponding triggers that trigger the monitoring of the multiple segments. An obtainer obtains characteristic data of the multiple segments. The characteristic data of the first communications session and characteristic data of a second communications session are grouped. The characteristic data of the first communications session is subject to common evaluation with characteristic data of the second communications session.

The present disclosure relates to agent call flow monitoring and evaluation. The agent call flow monitoring and evaluation described herein may be integrated into agent workstation software, machine agent software, and/or back-end software provided remotely from agent workstations or machine agents. The communications sessions between callers and human agents and/or machine agents may be over any type of communications network which can be served by human agents and/or machine agents.

An agent interface may be coupled to one or more support documents or tools. The agent interface may also be coupled to a business logic engine and a performance reporting engine. The output may provide analytical data to collectively measure the effectiveness of communications sessions involving linked components, identify areas for possible improvement, and provide recommendations for enhancements.

A combination of hardware and software may be used to monitor and measure agent activity for a given single call. The hardware and software is also used to monitor and measure agent call flow activity collectively across a sample of calls.

An agent call flow monitoring and evaluation interface may reside on an agent workstation, machine agent or dedicated server as middleware. Alternatively, the agent call flow monitoring and evaluation interface may be integrated with agent workstations or machine agents. The agent call flow monitoring and evaluation interface monitors instructions by an agent to obtain specific tools or content. The agent call flow monitoring and evaluation interface may monitor the use of tools and the display of content, and time stamp the beginning and end of such activities to determine duration. The agent call flow monitoring and evaluation interface may also provide preset document view thresholds. Anomalies can be detected and reported by the agent call flow monitoring and evaluation interface. Recommendations may be automatically provided to an enterprise for areas in need of review based on inconsistencies in tool use and document view durations. Recommendations may also be automatically provided to an enterprise for areas in need of review based on patterns of documents accessed across similar call types. Return on investment can be precisely measured for efforts intended to reduce average hold time or other broad performance metrics. The accuracy of automatic call distribution data can be measured. The agent call flow monitoring and evaluation interface may also ensure proper billing to clients. The performance of concurrent but different tasks can be individually measured, such as situations when agents handle multiple tasks at the same time.

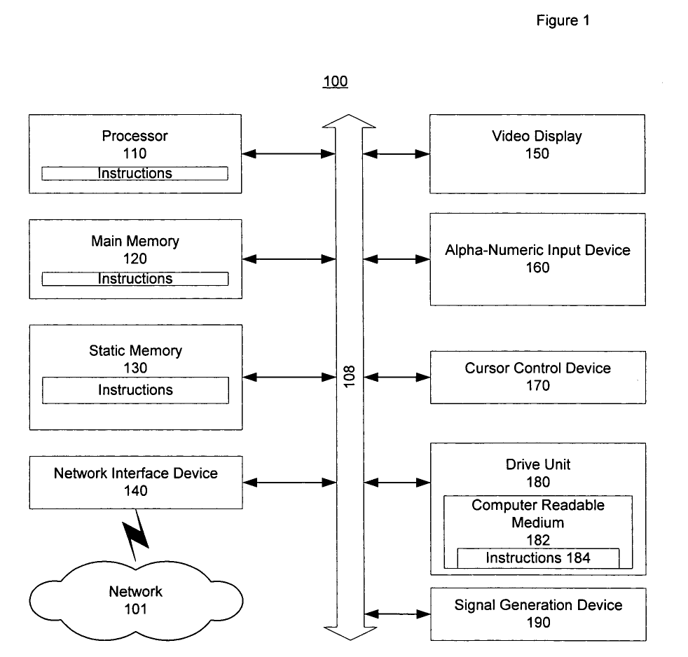

Referring to FIG. 1, an illustrative embodiment of a general computer system, on which agent call flow monitoring and evaluation can be implemented, is shown and is designated 100. The computer system 100 can include a set of instructions that can be executed to cause the computer system 100 to perform any one or more of the methods or computer based functions disclosed herein. The computer system 100 may operate as a standalone device or may be connected, e.g., using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a server and/or a client, a personal computer (PC), a desktop computer, a cell phone, a personal digital assistant (PDA), a mobile device, an internet protocol (IP telephone), a palmtop computer, a laptop computer, a communications device, a wireless telephone, a control system, a personal trusted device, a web appliance, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, e.g., a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g., software, can be embedded. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

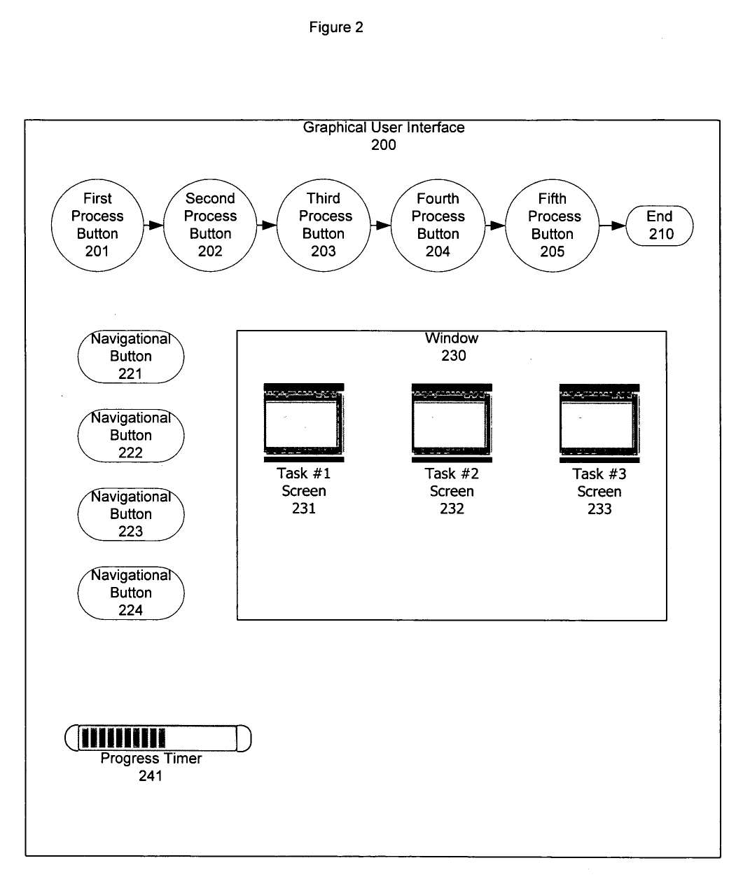

FIG. 2 shows an exemplary agent workstation graphical user interface 200 for agent call flow monitoring and evaluation. In FIG. 2, the graphical user interface 200 is used to display a framed interface with a series of progressive process buttons 201-205. Each of the progressive process buttons 201-205 is tied to one or more specific tasks to be completed for a particular call type. Each task may lead to a different task screen 231-233 being displayed in a content window 230. The different task screens 231-233 are each tied to specific tools and/or content required to complete the call. Content or an instruction interface is displayed by each task screen 231-233 within the content window 230 in the graphical user interface 200, and may be in the form of support documentation, input fields, progress indicators or any other standard desktop utilities used by a human agent.

Secondary navigational buttons 221-224 are also displayed on the graphical user interface 200. The navigational buttons 221-224 may be tied directly to the progressive process buttons 201-205. The selection of a navigational button 221-224 may change the progressive process buttons 201-205 by altering the number of steps for the call flow and/or the tools or content linked to the steps of the call flow. Additionally, the selection of a particular progressive process button 201-205 may alter the navigational buttons 221-224 in the same manner. An end button 210 is provided for the purpose of adding a timestamp to the end of a particular task or to the end of a particular call. A visual progress timer 241 is included in the graphical user interface 200 to assist agents by indicating progress relative to a predetermined or expected duration of a call for a particular call type or a predetermined or expected duration of a task within a call. Of course, a separate progress timer 241 may be provided for each task initiated during a call so that the agent is informed of progress relative to expectations for each such task. The progress timer(s) 241 may also vary depending on the type of call being processed and based upon which progressive process button 201-205 and/or navigational buttons 221-224 are pressed by the human agent. Additionally, an “overall” call session timer may be provided to display time passed during an entire call session rather than a subset of one or more segments of the single call session.

The appearance of each progressive process button 201-205 and the functionality performed when each progressive process button 201-205 is pressed may vary depending on which navigation button 221-224 is pressed. For example, if a human agent presses a first navigation button 221 to initiate a first process, the graphical user interface 200 may display a first sequence of progressive process buttons 201-205. However, if the human agent presses a second navigational button 222, the graphical user interface 200 may display a different second sequence of progressive process buttons 201-205. The progressive process buttons 201-205 may also vary depending upon information received at a human agent workstation from a machine agent that initially processes a call. Accordingly, graphical user interface 200 may be used interactively by a human agent to process calls of any number of different call types and any number of different communication modes (e.g., email, text message, telephone, voice over internet protocol).

The functionality described herein can be integrated with existing systems and components. Accordingly, a single process or multiple processes may be integrated with the graphical user interface 200. The functionality that is triggered by interaction with progressive process buttons 201-205 and/or the navigational buttons 221-224 may be assigned to correspond to predetermined functionality that can be invoked using existing graphical user interface icons or fields.

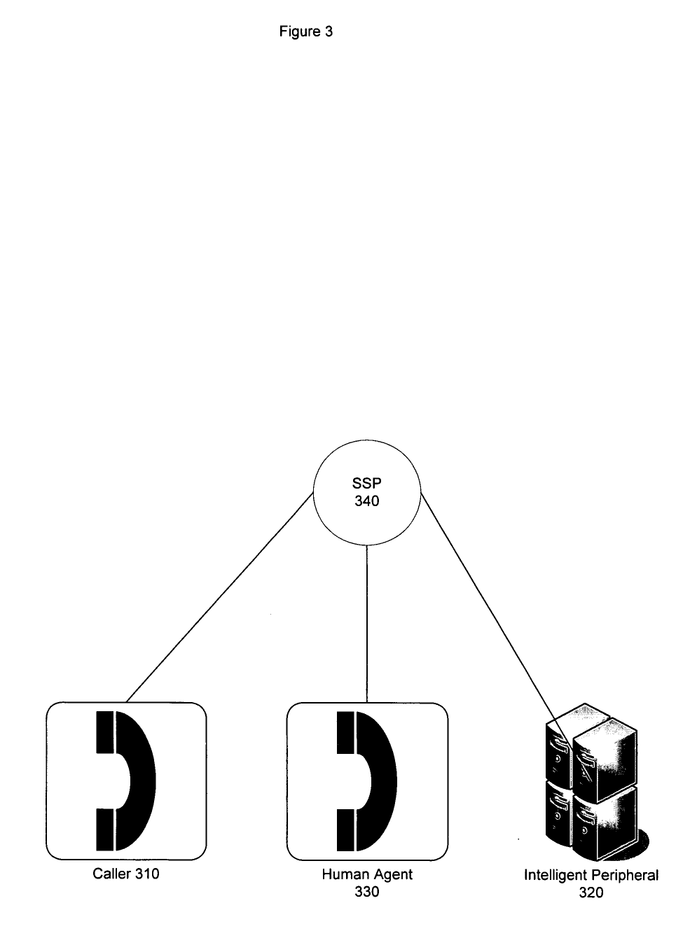

FIG. 3 shows an exemplary telecommunications network for agent call flow monitoring and evaluation. As shown, a caller using a telephone 310 is connected to an intelligent peripheral 320 through the public switched telephone network (PSTN), including, for example, a switch 340. The telephone call from the telephone 310 caller may be routed to the intelligent peripheral 320 when the caller inputs a telephone number for a service into the telephone 310. The switch 340 receives the call and routes the call to the intelligent peripheral 320 based upon the input number. Of course, the telephone 310 and the intelligent peripheral 320 need not be serviced by the same switch, and the call may be routed through any number of switches.

The intelligent peripheral 320 is a machine agent that provides automated functionality to a caller over the telecommunications network. The intelligent peripheral 320 may be an interactive voice response unit provided within a telecommunications network of a communications service provider or at a customer premise of a subscriber of a communications service provider. Although not shown in FIG. 3, the intelligent peripheral 320 may also communicate over a data network to receive instructions from a service control point or other intelligent call processor based upon information provided by the caller using the telephone 310. The intelligent peripheral 320 may also communicate over a data network to transfer information from the interaction with the caller using the telephone 310 to a human agent using the telephone 330 when the call is to be transferred from the intelligent peripheral 320 to the human agent using the telephone 330.

The intelligent peripheral 320 determines the type of service to be provided to the caller using the telephone 310. The intelligent peripheral 320 may provide voice instructions and requests for information to the caller over the telephone 310, and may receive voice responses and/or dual-tone multifrequency (DTMF) responses to the instructions and requests for information. The intelligent peripheral 320 may obtain information from the caller to determine whether it is necessary to transfer the call to the human agent using the telephone 330. Of course, the intelligent peripheral 320 may be used even when all calls are expected to be transferred to a human agent using telephone 330, in order to obtain preliminary information from the caller using the telephone 310 while minimizing personnel costs for the entity providing the service.

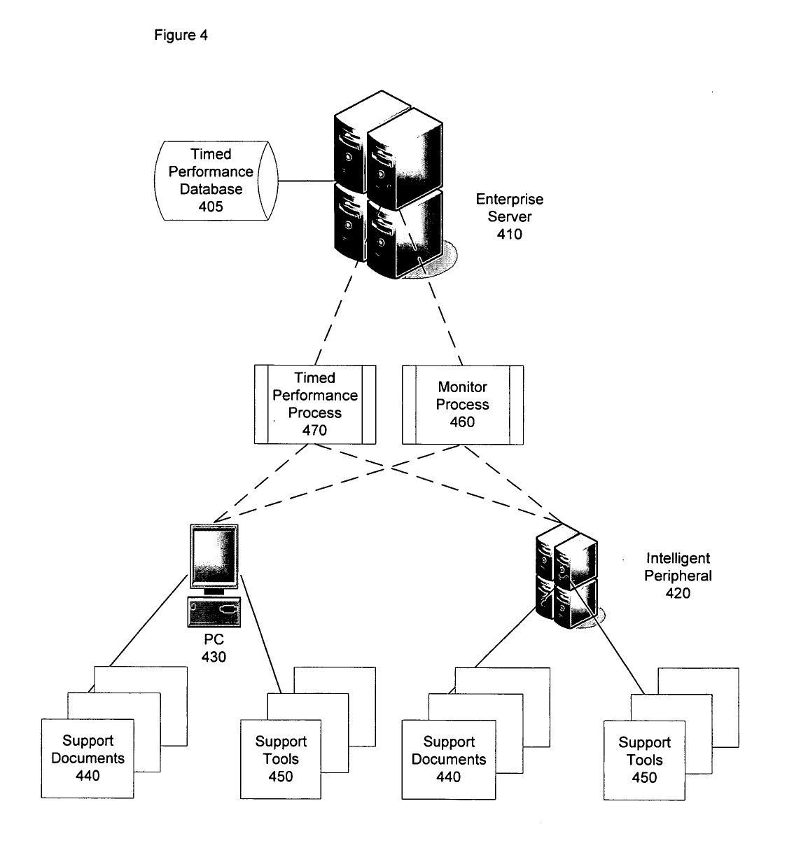

When the call is to be transferred to a human agent using the telephone 330, the switch 340 transfers the call to the human agent using the telephone 330. As an example, the human agent using the telephone 330 may be a service agent in a call center, and the telephone 330 may be a headset plugged into an agent workstation console. The caller using the telephone 330 requests information and provides responses to questions from the human agent. The human agent is provided with access to data networks (see FIG. 4) in order obtain information and provide the service to the caller. Accordingly, while communicating over a telephone line, an agent may also use computer systems and data resources to access tools and information to provide the service to the caller.

The agent call flow monitoring and evaluation may be integrated with software provided for the intelligent peripheral 320 and/or a workstation of the human agent using the telephone 330. Accordingly, individual segments of any communications session involving the intelligent peripheral 320 and/or the agent using the telephone 330 can be monitored and evaluated for performance efficiency.

FIG. 4 shows an exemplary network for agent call flow monitoring and evaluation. As shown, an agent personal computer 430 is connected to an enterprise server 410. The agent personal computer 430 may be a component of a human agent's workstation. Accordingly, the agent personal computer 430 may be used by the human agent in conjunction with the telephone 330 shown in FIG. 3, for example, to provide a service to a caller using the telephone 310 shown in FIG. 3.

An intelligent peripheral 420 is also provided in the same manner as intelligent peripheral 320 in FIG. 3. The intelligent peripheral 420 is a machine agent that may process calls from a caller either alone or in conjunction with the human agent using the agent personal computer 430.

The intelligent peripheral 420 and agent personal computer 430 may be connected to the enterprise server 410 through a data network such as an intranet or the internet. A timed performance database 405 is accessible to the enterprise server 410. The personal computer 430 may be provided with the graphical user interface 200 shown in FIG. 2. The enterprise server 410 may include a rules engine coupled to a content delivery system that delivers content to the personal computer 430. The enterprise server 410 is coupled over a data network to both the intelligent peripheral 420 and the agent personal computer 430. Accordingly, the enterprise server 410 may monitor agent activity as measured by the use of tools and content requested by an agent, and the duration of use of the use of the tools and content.

In other words, the enterprise server 410 may monitor and evaluate the personal computer 430 to measure individual performance specific to each task performed by the agent using the personal computer 430. The enterprise server 410 may also monitor and evaluate the call flow involving the intelligent peripheral 420 for the type and duration of each segment. The enterprise server 410 may also be networked to multiple intelligent peripherals 420 and personal computers 430 to obtain characteristic data for multiple agents. Accordingly, characteristic data for different agents, different call types and each segment of each call can be obtained. The characteristic data may be specific to one or more tasks within a given call type, as pre-defined within the timed performance database 405. The results of the monitoring may be evaluated in near real time by the enterprise server 410.

The agent call flow monitoring and evaluation is not dependent on a communications mode by which an agent receives calls. The agent call flow monitoring and evaluation is suitable for both telephone communications and other contact methods such as chat, email, voice over internet protocol communications or any other methods by which a caller may communicate with an agent. In the embodiment of FIGS. 3 and 4, the agent using the personal computer 430 is also the agent using the telephone 330. Accordingly, the use of telephony resources to communicate with callers may be replaced with use of internet resources within the scope and spirit of the present disclosure.

Further, the agent call flow monitoring and evaluation may be distributed among the agent personal computer 430, the intelligent peripheral 420 and the enterprise server 410. For example, monitoring modules may be integrated with software used by the agent personal computer 430 and the intelligent peripheral 420, and data output from the monitoring modules may be forwarded for evaluation by a separate evaluating module on the enterprise server 410.

Additionally, the agent call flow monitoring and evaluation is not dependent on any particular customer relations management software. Rather, the agent call flow monitoring and evaluation can be integrated with hardware and software from multiple vendors to provide standardized characteristic data.

As an example, the intelligent peripheral 320 or 420 and an agent using telephone 330 and personal computer 430 may provide technical assistance for customers of an internet service provider who call a technical assistance hotline. The callers are initially connected to the intelligent peripheral 320 or 420 which presents the callers with a variety of options as to the information or service they are requesting. In this example, the caller may be given options to press “1” for connection problems, “2” to reset a password, “3” for email help, or “4” to be connected with a human agent. In an embodiment, the call may be processed entirely by the intelligent peripheral 320 or 420, or routed to different agent workgroups depending on the information provided by the caller. However, for illustrative purposes of the example, when the call is transferred from the intelligent peripheral 320 or 420 to a human agent using personal computer 430, the call is routed to a general agent pool having agents trained to address all of the above-noted problems.

A call flow script for each different problem may differ in whole or in part from any other script. Further, the call flow through a script will vary as information is elicited from callers. Accordingly, the call flow of each call may vary depending on the interaction between the caller and the agent. However, when large numbers of calls are handled, as is common in the call center environment, similarities between even complex call flows are identifiable using the agent call flow monitoring and evaluation.

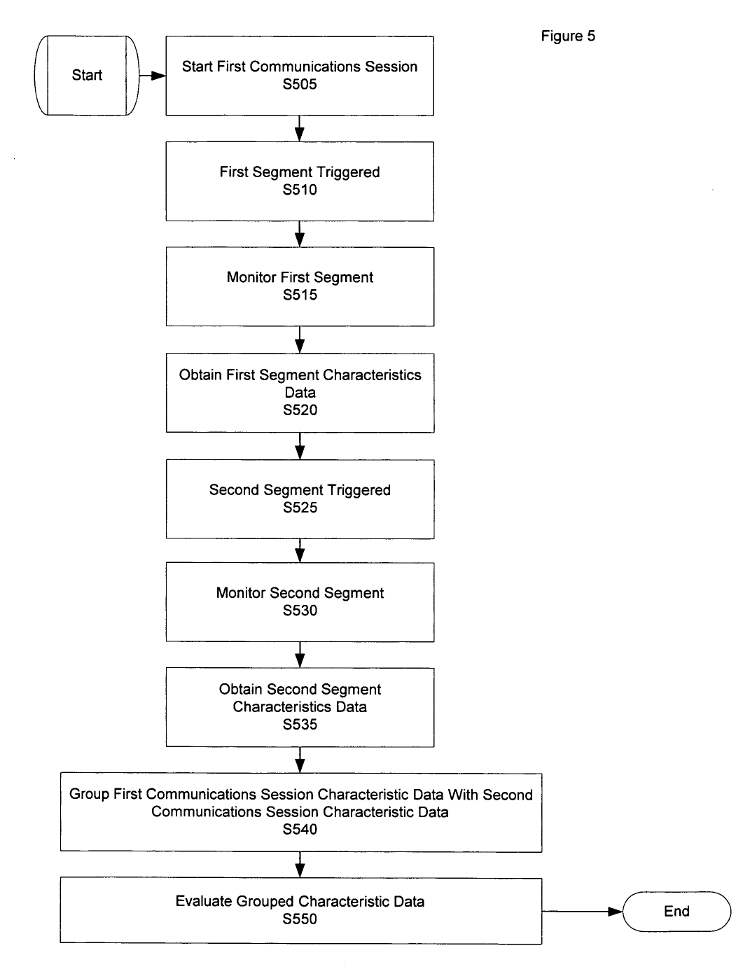

FIG. 5 shows an exemplary process for collecting characteristic data of a communications session. As shown, a first communications session is started at S505. The first communications session may be started at S505 when a human or machine agent initially receives a call and begins processing the call.

At S510 a first segment is triggered for monitoring. The triggering of a first segment for monitoring may be based upon a variety of actions. Triggering actions may include the agent answering a call, requesting access to predetermined data, checking a checkbox, opening or closing new screens, requesting tools such as a remote line tester, placing a call to a third party or transferring a call to a third party, ending a call or the use of a tool, closing a document, placing a caller on hold, or any other activity that can be detected during or after a call.

Different tools and systems which can be monitored include tools and documents retrieved from a knowledge-base or help document database accessed via the internet, an intranet or stored locally. Different tools and documents may be retrieved or opened using a customer relations management interface such as the graphical user interface 200 shown in FIG. 2. As an example, a computer telephony integration (CTI) teleset may be monitored when transfers occur. Additionally, an automated call distribution (ACD) system may be monitored for on hold periods and to calculate call-type-sensitive service levels. Other tools and systems which can be monitored include trouble shooting call flows, simulators, remote client software and broadband telephony testing tools.

Many of the tools described above are not themselves integrated directly with each other. For example, if an agent reaches a part of a knowledge base which directs the agent to utilize a separate broadband testing tool, the knowledge base may not actually recognize whether the agent actually utilizes the broadband testing tool.

At S515 the first segment is monitored. At S520, characteristic data of the first segment is obtained. For example, the characteristic data may be a duration of the first segment, a classification of the subject of the first segment, information on the parties involved in the first segment, a classification of the tools used or documents opened during the first segment, classification of preceding or following segments, or any other data that can be used to characterize the first segment.

At S525, a second segment is triggered. The second segment is monitored at S530, and characteristic data of the second segment is obtained at S535. The triggering and monitoring of the second segment at S525 and S530 may be similar to the triggering and monitoring of the first segment at S510 and S515, at least insofar as the second segment may be triggered by similar activities, and the second segment may be characterized by similar types of data.

At S540, characteristic data of the first communications session is grouped with characteristic data of a second communications session. The grouping of session data may be based upon similarities in the call flow, such as calls in which the same sequence of patterns is detected, or calls in which the same tool usage and document viewing occur. The grouping of session data may also be based upon generic similarities, such as the number to which such calls are made or the email address to which instant messenger inquiries are sent via instant messenger. Session data may also be grouped based on agent identity, workgroup identity, or a particular task performed during a call flow.

At S550, the grouped characteristic data is evaluated. The evaluation of grouped characteristic data may be performed, for example, by the enterprise server 410 which evaluates characteristic data obtained from numerous human and/or machine agents. The evaluation may involve summing and averaging the duration of particular segments or sequences of segments which are characterized by similar data.

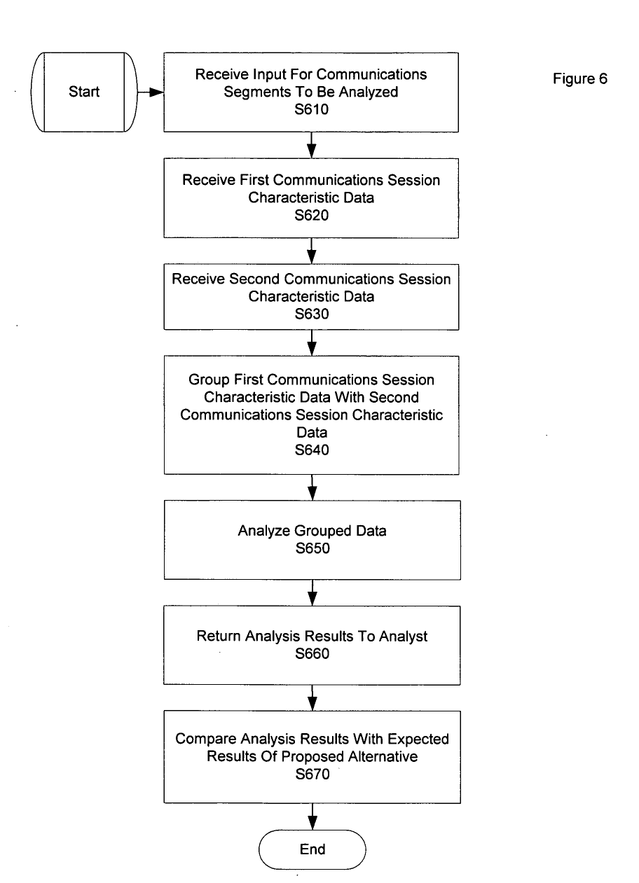

FIG. 6 shows an exemplary method of analyzing characteristic data of communications sessions. The method shown in FIG. 6 is directed to an analysis of existing data for purposes of comparison with expected results of proposed modifications to a call flow. At S610, input for communications segments to be analyzed is received. The input at S610 may be provided by an analyst. At S620, characteristic data of a first communication session is received. At S630, characteristic data of a second communication session is received. The characteristic data of the first communication session and second communication session are grouped at S640.

At S650, the grouped data is analyzed. For example, an average (mean) duration of the data of a particular type of segment or series of segments may be calculated. Statistical variance among the grouped data may be calculated, as well as any other type of mathematical metrics. The analysis may include identifying sub-groups of call segments and determining differences among the sub-groups. For example, a call segment that involves verifying a caller's account information may be parsed into two groups based on the task performed immediately prior to verifying. Accordingly, if a significant difference exists in the average duration of the verification segment depending on the type of segment preceding the verification segment, the difference can be detected and investigated by the analyst.

At S660 the analysis results are returned to the analyst and at S670 the analysis results are compared with the expected results of a proposed alternative. Of course, if the proposed change to a script has already been implemented, the comparison at S660 may be a comparison between analysis results after the change is made and analysis results before the change is made. Therefore, the analysis results can be used to determine whether a proposed change has resulted in the expected benefits.

The input at S610 may also be provided based upon predetermined instructions. Predetermined instructions to begin session analysis may be based on, for example, a determination that broad categories of calls are exhibiting undesirable characteristics such as increasing durations. As an example, if a call flow for technical support type #8 inquiries is expected to average 7 minutes, an analysis system may be programmed to pull and analyze data from the most recent 24 hours of such calls if the average increases over a 24 hour period to 8 minutes, 30 seconds.

The output from agent call flow monitoring and evaluation can also be used to adjust measurements provided by other systems, such as automatic call distributor (ACD) systems that calculate measurements such as service level. Service level measurements for automatic call distributor systems are based upon variables such as average handle time and/or average speed of answer. In the embodiment shown in FIG. 3, an automatic call distributor would be used to distribute calls to the intelligent peripheral 320 and the telephone 330 of a human agent. Accordingly, broad characteristics of telephony data for calls distributed to the intelligent peripheral 320 and/or the telephone 330 could be monitored and evaluated. The functionality of agent call flow monitoring and evaluation is used to supplement the functionality previously provided by automatic call distributor service level reporting, by monitoring and evaluating detailed characteristic data of communications sessions.

As described above, the ultimate benefit of a proposed change to a call flow may be a decrease in waiting or processing time for callers. Accordingly, if a proposal is made to alter a call flow or to inject a task into a call flow at one point and/or extract a task from the call flow at another, an analysis of characteristic data of the relevant segments can be used to determine whether the expectations are feasible.

Using the agent call flow monitoring and evaluation as described above, agent performance can be measured and enhanced in a manner not possible with broad estimates. With the level of measurable detail provided by the agent call flow monitoring and evaluation, a cycle of self-sustaining enhancements can be realized where wholesale modifications can be justified or incremental modifications can each be made after analysis shows that each modification is justified. Accordingly, the agent call flow monitoring and evaluation described above may be used by many different types of entities, including any entity that provides agents for customer service, as well as communications service providers, middleware software providers, customer relations management software providers, contact center service providers, and/or any resellers or consulting firms for such providers.

The agent call flow monitoring and evaluation also provides detailed data that can be used as evidence in disputes between parties, such as when promised improvements are not realized or service level commitments are not met.

Although the present specification describes components and functions that may be implemented in particular embodiments with reference to particular standards and protocols, the disclosure is not limited to such standards and protocols. Each of the standards, protocols and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather, the disclosure extends to all functionally equivalent structures, methods, and uses such as are within the scope of the appended claims.

What is claimed is:

1. A method of monitoring agent performance, comprising:
monitoring a plurality of segments of a first communications session based on a corresponding plurality of triggers that trigger the monitoring of the plurality of segments; and
obtaining characteristic data of the plurality of segments,
wherein the characteristic data of the first communications session and characteristic data of a second communications session are grouped, and
wherein the characteristic data of the first communications session is subject to common evaluation with the characteristic data of the second communications session.

2. The method of monitoring agent performance of claim 1,
wherein the plurality of triggers are generated based on agent interaction with at least one agent interface.

3. The method of monitoring agent performance of claim 2,
wherein the agent interaction with the at least one interface comprises a request to display specified content.

4. The method of monitoring agent performance of claim 1, further comprising:
time stamping the start of each segment.

5. The method of monitoring agent performance of claim 4, further comprising:
time stamping the end of each segment.

6. The method of monitoring agent performance of claim 1, further comprising:
comparing a duration of each segment with a predetermined threshold.

7. The method of monitoring agent performance of claim 1, further comprising:
displaying a duration of a segment to the agent in association with a predetermined threshold.

8. The method of monitoring agent performance of claim 1,
wherein the common evaluation determines a mean duration of at least one common segment of the first and the second communications sessions.

9. The method of monitoring agent performance of claim 1,
wherein the common evaluation determines a duration variance of at least one common segment of the first and the second communications sessions.

10. The method of monitoring agent performance of claim 1,
wherein a first segment and a second segment are temporally differentiable.

11. The method of monitoring agent performance of claim 1,
wherein a first segment corresponds to the use of a first tool by an agent and a second segment corresponds to the use of a second tool by the agent.

12. The method of monitoring agent performance of claim 1,
wherein a first segment corresponds to a period where a first document is open for the agent and a second segment corresponds to a period where a second document is open for the agent.

13. The method of monitoring agent performance of claim 1,
wherein the plurality of triggers comprise at least one call initiation to a third party.

14. The method of monitoring agent performance of claim 1,
wherein the start of the first communications session is measured from a time when the agent receives a call.

15. The method of monitoring agent performance of claim 14,
wherein the agent receives the call after the call is processed by an intelligent peripheral.

16. The method of monitoring agent performance of claim 15,
wherein characteristic data of an interaction between a caller and the intelligent peripheral is subject to the common evaluation with the characteristic data of the first communications session and the characteristic data of the second communications session.

17. The method of monitoring agent performance of claim 1,
wherein the first segment and the second segment correspond to differentiable progressive agent activities during the first communications session.

18. The method of monitoring agent performance of claim 17,
wherein the differentiable progressive agent activities correspond to tasks required for the agent to complete the call.

19. A computer readable medium for storing a program that monitors agent performance, comprising:
a monitoring code segment that monitors a plurality of segments of a first communications session based on a corresponding plurality of triggers that trigger the monitoring of the plurality of segments; and
an obtaining code segment that obtains characteristic data of the plurality of segments,
wherein the characteristic data of the first communications session and characteristic data of a second communications session are grouped, and
wherein the characteristic data of the first communications session is subject to common evaluation with characteristic data of the second communications session.

20. A module for monitoring agent performance, comprising:
a monitor that monitors a plurality of segments of a first communications session based on a corresponding plurality of triggers that trigger the monitoring of the plurality of segments; and
an obtainer that obtains characteristic data of the plurality of segments;
wherein the characteristic data of the first communications session and characteristic data of a second communications session are grouped, and
wherein the characteristic data of the first communications session is subject to common evaluation with characteristic data of the second communications session.
